(19) United States
(12) Patent Application Publication
(10) Pub. No.: US 2004/0247091 A1
(43) Pub. Date: Dec. 9, 2004

(54) Telephone apparatus and communication system

(75) Inventor: Kenichi Shibata, Fukuoka-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/858,197

(22) Filed: Jun. 2, 2004

(30) Foreign Application Priority Data
Jun. 6, 2003 (JP) 2003-161800

(51) Int. Cl. H04M 11/00; H04M 1/64

(52) U.S. Cl. 379/88.13; 379/88.22

(57) ABSTRACT

The invention includes a first memory capable for storing a telephone number attached with a predetermined number, a second memory for storing the predetermined number, an interface for connecting the telephone apparatus with the telephone line through a PBX, a control portion for controlling a whole other portions, a comparing portion for comparing the predetermined number in the first memory which is selected as a destination for an E-mail and the predetermined number in the second memory, a deleting portion for delete the attached predetermined number from the telephone number as the destination for the E-mail when the comparing portion determines the predetermined number in the first memory which is selected as the destination for the E-mail corresponds to the predetermined number in the second memory and a mail-sending portion for sending an E-mail together with the telephone number as the destination to the E-mail server.

### BACKGROUND OF THE INVENTION

The present invention relates to a telephone apparatus which has an E-mail transmission function and a communication apparatus including the telephone apparatus.

The conventional telephone which is connected with PBX (private branch exchange) is shown in FIG. 7.

Referring to FIG. 7, 1A is designated to a conventional telephone which is connected with a PBX (not shown). Reference numeral 11A designates a control portion which controls the whole portions of the conventional telephone, 12 designates a button-operating portion which a user operates, 13 designates a display portion which displays characters and images, and 14 designates a memory which stores a set of numbers including a telephone number and an outer line access number attached at the top of the telephone number in pairs. Also, the memory 14 stores a dialing code corresponding to the set of numbers.

Reference 15 designates a circuit interface which connects the conventional telephone with other telephone located outside through a telephone line (not shown), 16 designates a microphone portion which is connected with the interface 15, and 17 designates a speaker portion which is connected with the interface 15.

FIG. 8 shows a schematic diagram of a conventional communication system including the conventional telephone 22 which is connected with the PBX 21.

Referring to FIG. 8, reference numeral 2 designates a house, 3, 4 and 6 designate public exchanges (local telephone switches), 5 designates other house, and 7 designates an E-mail server. Also, the telephone 22 is connected with the PBX 21 through the interface 15.

The operation of the conventional communication system is explained as follows.

The telephone number of the telephone 51 located at the house 5 is stored in the memory 14, and the memory 14 also stores an outer line access number “0” at the top of the telephone number, which allows to be recognized apart from the telephone number.

When a user at the house 2 gives a call to the telephone 51 by the telephone 22, the user inputs the dialing code for the telephone 51 by operating the operation portion 12. After the input of the code, the telephone 22 reads out a set of numbers (the access number “0” and telephone number of the telephone 51), for example, “01234445555” from the memory 14 and transmits the set of numbers to the PBX 21.

In the PBX 21, as the telephone number is attached with the outer line access number “0”, the call by the set of the numbers is recognized to be not an extension call but the call through the telephone line. After a calling operation by the user, the number “1234445555” is transmitted to the Public Exchange 3 as the telephone number of the telephone 51 at the house 5.

That is, the PBX 21 catches the telephone line when the PBX 21 receives the first number “0” and connects the telephone 22 with the telephone line and transmits the number “1234445555” to the telephone line. Then, the telephone 22 is connected with the telephone 51 through the public exchanges 3 and 4.

On the other hand, when the user sends an E-mail by the telephone 22, the user inputs the dialing codes for the server 7 and the dialing code for the telephone 51 by using the operation portion 12 of the telephone 22. For example, the user inputs the dialing code corresponding to the set of numbers “09993336666” to connect the telephone 22 with the server 7 and, then, inputs the code corresponding to the set of numbers for the telephone 51 at the house 5.

As the telephone 22 recognizes the first number of the above input set of numbers to be the outer line access number, the telephone 22 transmits “9993336666” as the telephone number of the E-mail server 7 to the public exchange 3.

That is, the PBX 21 connects with the telephone line by receiving the outer line access number “0” from the telephone 22 and transmits “9993336666” to the telephone line after connecting the telephone 22 with the telephone line.

Then, the telephone 22 is connected with the E-mail server 7 through the public exchanges 3, 6 and the number “01234445555” as the telephone number of the telephone at the house 5 is transmitted to the E-mail server 7 as the destination-telephone number for the E-mail.

However, if the E-mail server 7 receives the set of number “01234445555” and detects the first number “0”, the server 7 can not recognize the received set of number as the telephone number for the E-mail.

Therefore, the conventional telephone cannot send an E-mail if the telephone number for specifying a destination of the E-mail is attached with the outer line number at the top of the received telephone number. If the user wants to send the E-mail by the conventional telephone, the user needs to delete the outer line number or to input the telephone number manually.

### SUMMARY OF THE INVENTION

The object of the invention is to provide a telephone apparatus and a communication system which are capable to send an E-mail through a PBX without a complicated operation by a user.

The telephone apparatus of the present invention includes: a first memory capable for storing a telephone number attached with a predetermined number, a second memory for storing the predetermined number, an interface for connecting said telephone apparatus with the telephone line through a PBX, a control portion for controlling a whole other portions, a comparing portion for comparing the predetermined number in said first memory which is selected as a destination for an E-mail and the predetermined number in said second memory, a deleting portion for deleting the attached predetermined number from the telephone number as the destination for the E-mail when said comparing portion determines the predetermined number in said first memory which is selected as the destination for the E-mail corresponds to the predetermined number in said second memory and a mail-sending portion for sending an E-mail together with the telephone number which the predetermined number is deleted as the destination to the E-mail server.

### BRIEF DESCRIPTION OF THE DRAWINGS

FIG. 1 shows a schematic block diagram of the preferred embodiment of the telephone apparatus of the present invention.

FIG. 2 shows a schematic diagram of the preferred embodiment of the communication system of the present invention.

FIG. 3 shows a schematic structure of the first memory of, the preferred embodiment of the telephone apparatus of the present invention.

FIG. 4 shows a schematic structure of the second memory of the preferred embodiment of the telephone apparatus of the present invention.

FIG. 5 shows a schematic block diagram of the preferred embodiment of the control portion in the telephone apparatus of the present invention.

FIG. 6 shows a flowchart indicating an operation of preferred embodiment of the telephone apparatus of the present invention.

FIG. 7 shows a schematic block diagram of the conventional telephone apparatus with a PBX.

FIG. 8 shows a schematic diagram of the conventional communication system including a conventional telephone.

### DETAILED DESCRIPTION OF THE PREFERRED EMBODIMENTS

The embodiment of the telephone apparatus and the communication system of the present invention is explained along to the drawings as follows.

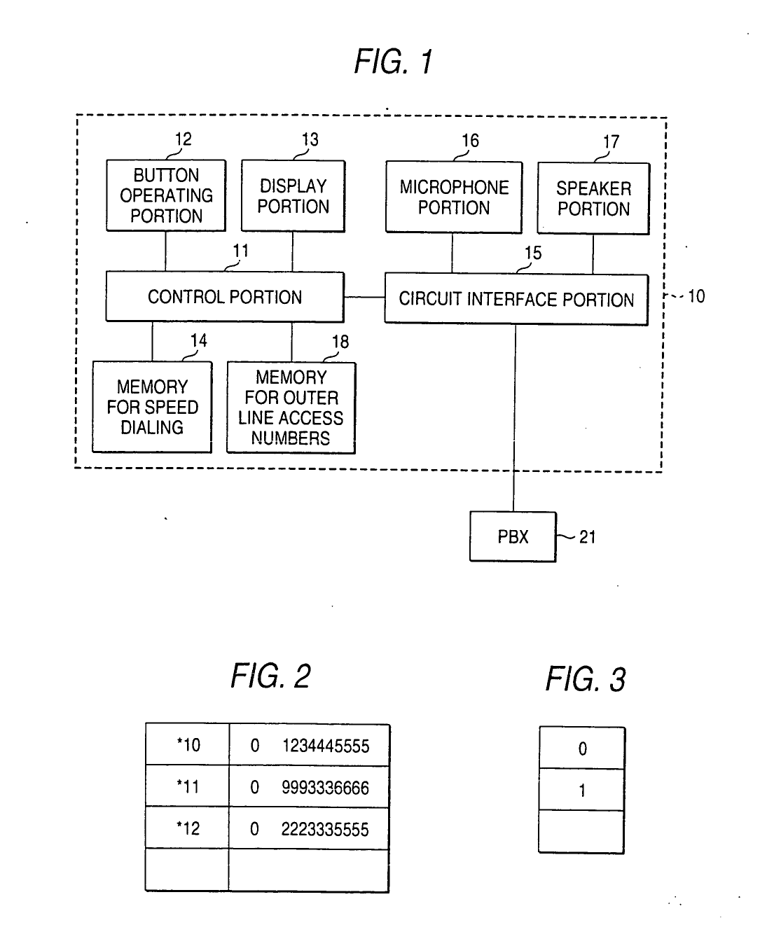

Referring to FIG. 1, a schematic block diagram of the preferred embodiment of the telephone apparatus of the present invention is shown therein.

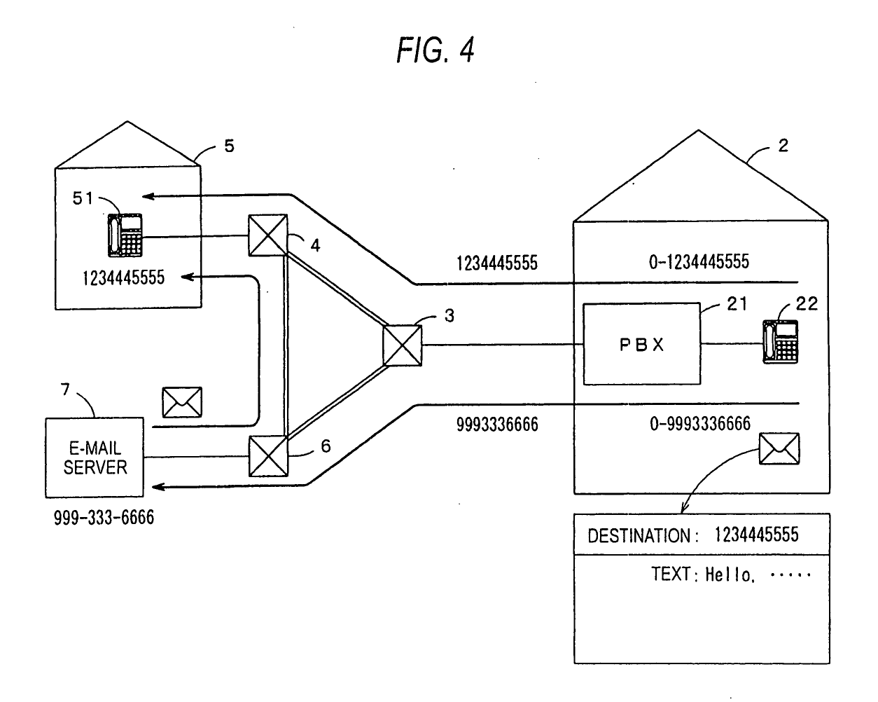

In FIG. 1, reference numeral 10 designates a telephone apparatus which is connected with a PBX (private branch exchange) 21 (referring to FIG. 4) and by which is capable for talking with others, sends and receives an E-mail, 11 designates a control portion which controls a whole of the telephone apparatus, 12 designates a button-operating portion for inputting several kinds of information, 13 is designated to a display for displaying characters and images, and 14 is designated to a first memory for storing a telephone number and an outer line access number at the top of the telephone number (referring to FIG. 2).

The first memory 14 also stores a dialing code corresponding to a set of the-telephone number and the outer line access number (referring to FIG. 2). Reference numeral 15 designates an interface which allows the telephone apparatus to connect with the other telephone through a PBX and a telephone line, 16 designates a microphone connected with the interface 15, 17 designates a speaker connected with the interface 15, and 18 is designated to a second memory which stores the outer line access numbers.

In the present embodiment, the second memory is capable for storing three outer line access numbers and stores two outer line access numbers “0” and “1” (referring to FIG. 3).

In the first memory 14, the telephone number of the telephone 51 located at the house 5 with the outer line access number “0” is stored in pairs. (referring to FIG. 2) In the second memory 18, outer line access numbers “0” and “1” is stored (referring to FIG. 3). The telephone number and the access number are stored to be recognized separately in the first memory 14.

The access number allows the telephone apparatus to connect outer telephone through the PBX and the telephone line.

Referring to FIG. 4, reference numerals 2 and 5 designate houses, 3, 4 and 6 designate public exchanges (local telephone switch), 7 designates an E-mail server, 22 is designated to a telephone apparatus, and 51 is designated to a conventional telephone. Also, the interface 15 of the telephone apparatus 22 is connected with the PBX 21.

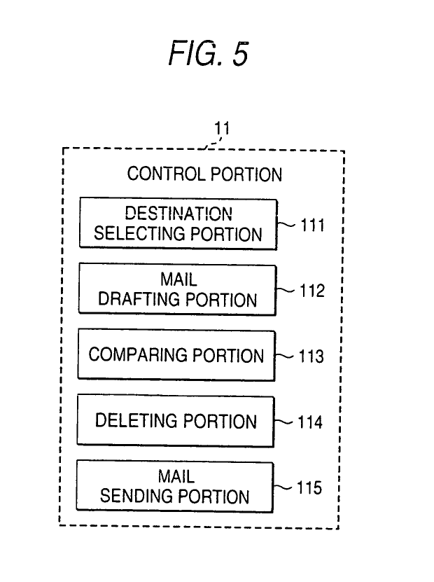

Referring to FIG. 5, a detailed structure of the control portion 11 is shown therein. The operation of the control portion is conduced by executing a program (not shown) stored in the control portion.

Reference numeral 111 designates a destination-selecting portion which selects a destination for an E-mail by a code input from the button-operation portion 12, 112 designates a mail-drafting portion which drafts an E-mail, 113 designates a comparing portion which compares an outer line access number of the number read out from a memory 14 and an outer line access number stored in the memory 18, 114 designates a deleting portion which delete the outer line number in the read number in a case where the outer line number read out from the number in the memory 14 corresponds with the outer line number in the memory 18, and 115 designates a sending portion which sends an E-mail.

The operation of the preferred embodiment of the communication system of the present invention is explained as follows.

When a user at the house 2 gives a call to a person at the house 5, the user inputs memory dialing code (*11) for the telephone number of the person' telephone 51.

On the basis of the code, the control portion 11 of the telephone apparatus 22 controls the destination selecting portion 111 to retrieve the stored set of the numbers “01234445555” in the memory 14 and to read out the set of the numbers. Then, the interface 15 transmits the set to the PBX 21.

Next, the PBX recognizes that this call is not an extension call but the one through the telephone line as the set of numbers includes “0” at the top.

When the user operates to call, the PBX transmits the set of numbers which the access number “0” is deleted, that is, the number “1234445555” to the public exchange 3 as telephone number. Namely, the PBX catches the telephone line as the received number includes the access number “0” at the top of, connects the telephone apparatus 22 with the telephone line and transmits the number “1234445555” to the public exchange 3 through the telephone line.

Thereby, the telephone apparatus 22 connects the telephone 51 which has a telephone number “1234445555” through the public exchanges 3,4.

After the connection between the telephone apparatus 22 and the telephone 51, the user can talk with the person at the house 5.

Also, the operation to send an E-mail by the telephone apparatus is explained as follows.

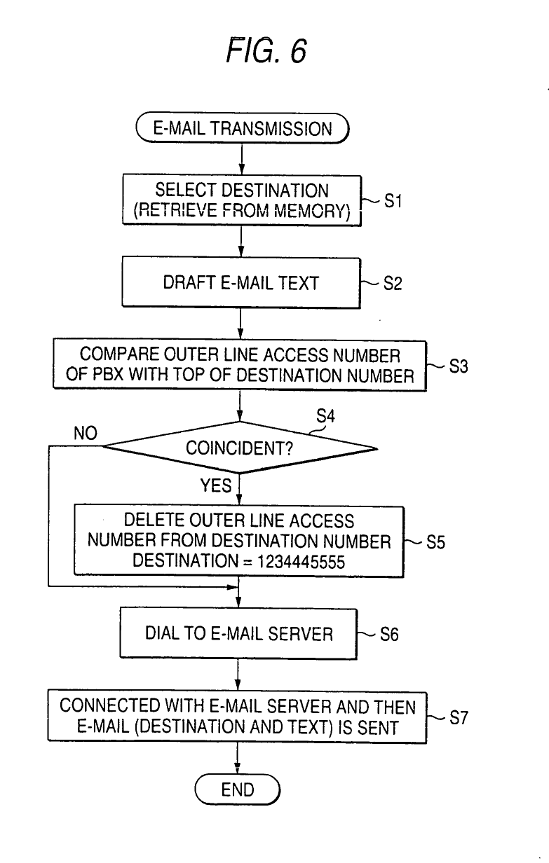

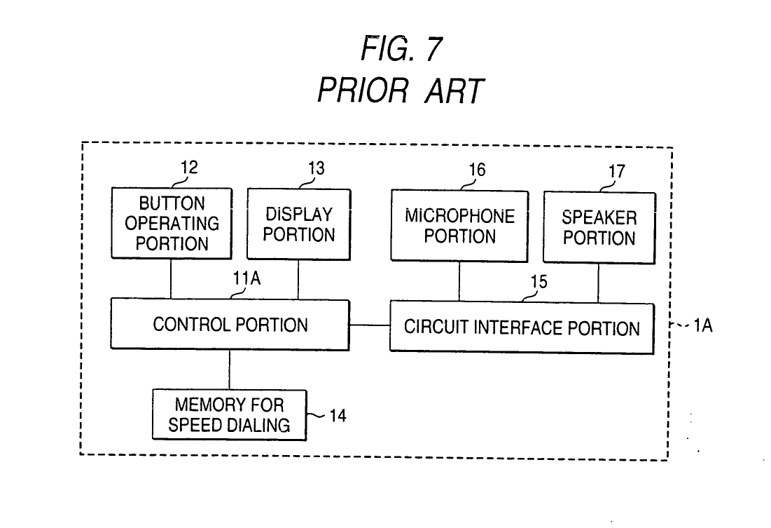

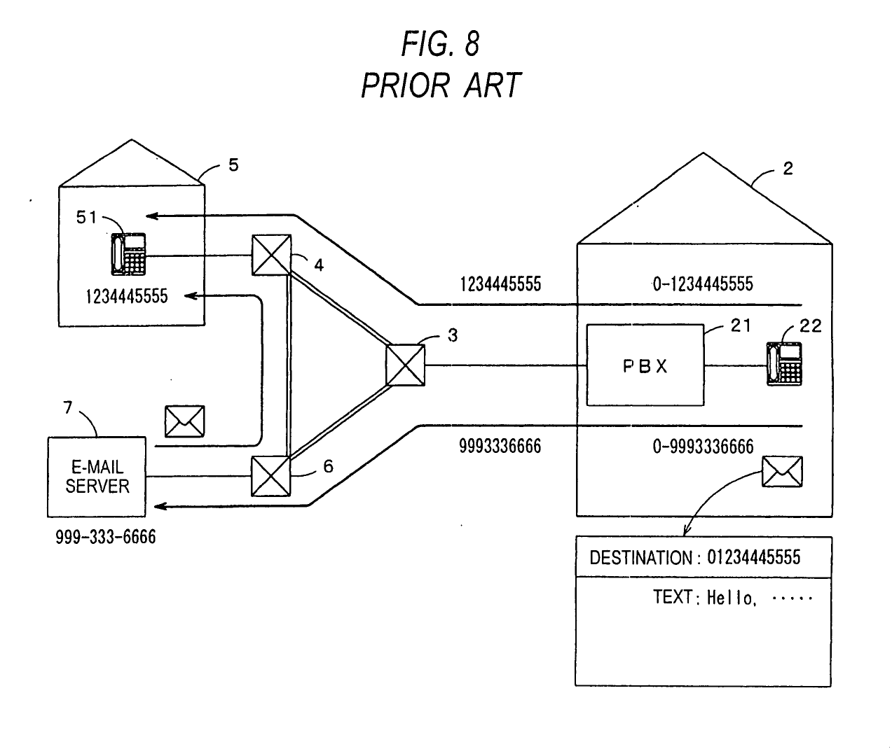

Referring to FIG. 6, the user inputs the code (*10) for the telephone number of the telephone 51 at the house 5 as the destination for the E-mail (STEP1).

The destination-selecting portion 111 retrieves the telephone number, “01234445555” on a basis of the code (*10), and reads out it from the memory 14.

Then, the user drafts an E-mail by using the mail-drafting portion 112 (STEP2).

Next, the comparing portion 113 compares the outer line number of the read number from the memory 14 as the destination telephone number for E-mail (the top of the read number) with the outer line code in the memory 18 (STEP 3).

The outer line access number in the memories 14 and 18 are capable for being changed by operating the button-operating portion 12.

Also, the comparing portion 113 determines whether or not the access number read out from the memory 14 is coincident with the access number in the memory 18 (STEP 4).

If the comparing portion 113 determines the outer line access number read from the memory 14 is coincident with the access number in the memory 18, the deleting portion 114 deletes the outer line access number “0” from the read number “01234445555” as the destination for E-mail (STEP 5).

The telephone number “1234445555” is automatically attached to the E-mail as the destination telephone number by the mail sending portion 115.

Furthermore, when the user inputs the code (*11) for the mail server to connect the telephone 22 with server 7 after attaching the destination telephone number to the E-mail, on the basis of the code (*11), the control portion 11 of the telephone apparatus 22 controls the destination selecting portion 111 to retrieve the stored set of the numbers “09993336666” in the memory 14 and to read out the set of the numbers. Then, if the user operates the telephone 22 to connect the telephone 22 to the mail server 7, the interface 15 transmits the set to the PBX 21.

After the PBX receives the set of the numbers, the PBX recognizes that this call is not an extension call but the one through the telephone line as the set of numbers includes “0” at the top.

The PBX transmits the set of numbers which the access number “0” is deleted, that is, the number “9993336666” to the public exchange 3 (STEP6).

Namely, the PBX catches the telephone line as the received number includes the access number “0” at the top and connects the telephone apparatus 22 with the telephone line and transmits the number “9993336666” to the public exchange 3 through the telephone line.

Thereby, the telephone apparatus 22 connects the mail server 7 which has a telephone number “9993336666” through the public exchanges 3,6.

After the mail-sending portion 115 dials to the E-mail server 7 (STEP 6), the telephone apparatus 22 is connected with the E-mail server 7 and the mail sending portion 115 sends the E-mail to the E-mail server 7 (STEP 7). Then, on the basis of the telephone number, the E-mail server 7 directly sends the E-mail to the telephone 51 at the house 5 or sends a notice that the sever 7 has received the E-mail for the telephone 51 to the telephone 51. If the telephone 51 receives the notice from the E-mail server, the user of the telephone 51 can send the request for sending the E-mail to the server 7.

As explained above, the preferred embodiment of the invention can simplify the operation for sending an E-mail through a PBX by a user.

The present disclosure relates to subject matter contained in priority Japanese Patent Application No. 2003-161800 filed on Jun. 6, 2003, the content of which is herein expressly incorporated by reference in its entirety.

It should be understood that various alternatives to the structures described herein may be employed in practicing the present invention. It is intended that the following claims define the invention and that the structure within the scope of these claims and their equivalents be covered thereby.

What is claimed is:

1. A telephone apparatus comprising:
a first memory storing a telephone number attached with a predetermined number;
a second memory for storing the predetermined number;
an interface for connecting said telephone apparatus with the telephone line through a PBX;
a control portion for controlling a whole other portions;
a comparing portion for comparing the predetermined number in said first memory which is selected as a destination for an E-mail, and the predetermined number in said second memory;
a deleting portion for delete the attached predetermined number from the telephone number as the destination for the E-mail when said comparing portion determines the predetermined number in said first memory which is selected as the destination for the E-mail corresponds to the predetermined number in said second memory; and
a mail-sending portion for sending an E-mail together with the telephone number as the destination to the E-mail server through the PBX.

2. A telephone apparatus according to claim 1, wherein said mail sending portion automatically attaches the telephone number as the destination for the E-mail.

3. A telephone apparatus according to claim 1, wherein said second memory stores a plurality of the outer line access numbers.

4. A communication system which includes a PBX and a telephone apparatus:
said PBX allowing said telephone apparatus to connect with the telephone line,
said telephone apparatus including;
a first memory storing a telephone number attached with a predetermined number,
a second memory for storing the predetermined number, an interface for connecting said telephone apparatus with the telephone line through said PBX,
a control portion for controlling a whole other portions,
a comparing portion for comparing the predetermined number in said first memory which is selected as a destination for an E-mail, and the predetermined number in said second memory,
a deleting portion for delete the attached predetermined number from the telephone number as the destination for the E-mail when said comparing portion determines the predetermined number in said first memory which is selected as the destination for the E-mail corresponds to the predetermined number in said second memory and,
a mail-sending portion for sending an E-mail together with the telephone number as the destination to the E-mail server through said PBX.

5. A communication system according to claim 4, wherein said mail sending portion automatically attaches the telephone number as the destination for the E mail to the E-mail.

6. A communication system according to claim 4, wherein said second memory stores a plurality of the outer line access numbers.
